(19) United States
(12) Patent Application Publication
(10) Pub. No.: US 2011/0228700 A1
(43) Pub. Date: Sep. 22, 2011

(54) Subframe Allocation for In-Band Relay Nodes

(75) Inventors: Gunnar Mildh, Sollentuna (SE); Peter A. Moberg, Stockholm (SE); Jessica Ostergaard, Stockholm (SE)

(73) Assignee: Telefonaktiebolaget LM Ericsson (publ), Stockholm (SE)

(21) Appl. No.: 12/833,234

(22) Filed: Jul. 9, 2010

Related U.S. Application Data
(60) Provisional application No. 61/314,380, filed on Mar. 16, 2010.

(51) Int. Cl. H04L 12/28; H04B 7/14

(52) U.S. Cl. 370/254; 370/315

(57) ABSTRACT

A coordinating node avoids or reduces interference between relay nodes by coordinating subframe allocation for the interfering relay nodes. The coordinating node identifies the interfering relay nodes that require the same subframe allocation and provides the necessary signaling so that the involved nodes get information concerning the subframe allocations. The system may be implemented using a centralized node (e.g., OAM) or distributed coordinating nodes.

### RELATED APPLICATION

This application claims the benefit of U.S. Provisional Patent Application 61/314,380, filed Mar. 16, 2010, which is incorporated herein by reference.

### BACKGROUND

In LTE systems (3GPP LTE Rd-10), the use of relays has been proposed to improve the coverage and capacity of LTE networks. A relay node can be positioned between a donor eNB and a user terminal (UT) so that transmissions between the eNB, referred to as the donor eNB, and the UE are relayed by the relay node. Release 10 of LTE supports Type 1 relay nodes. A type 1 relay controls cells, each of which appears to a user terminal as a separate cell distinct from the donor cell. The cells controlled by the relay node have their own Physical Cell ID (as defined in LTE Rel-8) and transmit their own synchronization channels, reference symbols etc. In the context of single-cell operation, the user terminal receives scheduling information and HARQ (Hybrid Automatic Repeat-reQuest) feedback directly from the relay node and sends its control channels (SR/CQI/ACK) to the relay node. A type one relay is backward compatible and appears as a base station (eNodeB) to Release 8 user terminals. Thus, from the perspective of a user terminal, there is no difference being served by a base station or a Type 1 relay node.

Transmissions between the relay node and the donor base station are over a radio interface called the Un interface. The Un interface is referred to herein as the backhaul link. Transmissions between user terminal and relay node are over a radio interface called the Uu interface. The Uu interface is referred to herein as the access link. The access link is the same as for direct communication between the user terminal and base station without a relay in between. If the transmissions on backhaul and access links are within the same frequency band, the relay node is referred to as inband relay node. In case the transmissions are on a separate frequency bands, the relay node is referred to as outband relay node.

To enable inband relay nodes to be functional, the relay node cannot transmit and receive at the same time on the same frequency, since this could cause intolerable self-interference. For the downlink, certain subframes are configured as MBSFN subframes so that the relay node does not transmit anything in its own cell on the access interface. During an MBSFN subframe, the user terminals in the relay cell do not expect to receive any reference signals or downlink (DL) data from the relay node beyond what is transmitted in the first two OFDM symbols of the subframe. Instead, the relay node listens to the downlink transmissions on the backhaul link during the rest of these subframes (which are hence used for carrying downlink data from the donor eNB to the relay nodes). Similarly, in the uplink, the relay node cannot simultaneously listen to transmissions from the user terminal on the access link and transmit to its donor base station on the backhaul link. However, in the uplink, there is no problem with the relay node temporarily disregarding the access link. Thus, interference can be avoided by not scheduling any data on the relevant subframes.

The performance of a relay-enhanced system is dependent on the subframe allocations. Alternative configurations can also achieve different objectives when it comes to capacity, coverage, peak rates etc. For example, if the backhaul link (the Un interface) is the bottleneck, it is beneficial to have as many subframes allocated to the backhaul as possible. This is likely to happen if there are many relay nodes served by the same donor base station or if the traffic in a certain relay cell is high. If the backhaul link (Un interface) is of good radio quality compared to the access link (Uu interface), it is better to have more subframes allocated to the access link since this is limiting. Generally, the load distribution within the donor station cell is an important factor for subframe allocation. The optimal subframe allocation is likely to depend on the relation between traffic served directly by the donor base station and the traffic served by relay nodes. The interference between relay nodes, as well as between relay nodes and base stations, may be considered in making subframe allocations. Hence, the optimal allocation may be different for different relay nodes.

Configuring relay nodes in a system with different subframe allocations may lead to an interference problem between multiple relay nodes. The problem of interfering relay nodes can be solved by having the same subframe allocation in all relay nodes that risk interfering with each other. The drawback of this approach, however, is that it would be difficult to optimize the resource usage when all relay nodes are constrained to share the same subframe allocation.

### SUMMARY

The present invention provides a method and apparatus to avoid interference between relay nodes by coordinating subframes for interfering relay nodes. The present invention provides a mechanism to identify interfering relay nodes that require the same allocation and provides the necessary signaling so that the involved nodes get information concerning the restrictions of the subframe allocations. The system may be implemented using a centralized node (e.g., OAM) or distributed coordinating nodes.

One exemplary embodiment of the invention comprises a method of configuring a relay node. The method can be performed manually, or by a management node. The method comprises identifying one or more neighboring relay nodes; determining interference information for the neighboring relay nodes; and configuring a subframe allocation based on the interference information for the neighboring relay nodes. In some embodiments, the relay node is assigned to a relay node pool based on the interference information so that all relay nodes in the same relay node pool use a common subframe allocation pattern. Relay nodes in the relay node pool may be served by the same or different base stations.

Another exemplary embodiment comprises a coordinating node for configuring a relay node. The coordinating node comprises a signaling interface to receive interference information regarding one or more neighboring relay nodes; and a processor programmed to configure a subframe allocation for a relay node based on the interference from other relay nodes.

The invention enables the best possible subframe allocation for relay nodes in a system, avoiding the intolerable interference that might occur without in the absence of coordination. It also helps in the deployment of relay nodes because there is less concern of inter-relay node interference.

### BRIEF DESCRIPTION OF THE DRAWINGS

FIG. 1 is a schematic diagram of a communication system according to the present invention including a relay node.

FIG. 2 is a schematic diagram showing one representative subframe allocation for a relay node.

FIG. 3 illustrates interference between neighboring relay nodes.

FIG. 4 illustrates an exemplary method of subframe allocation according to one embodiment.

FIG. 5 illustrates the use of relay pools for relay nodes using a common subframe allocation pattern.

FIG. 6 illustrates an exemplary coordinating node for determining subframe allocations.

### DETAILED DESCRIPTION

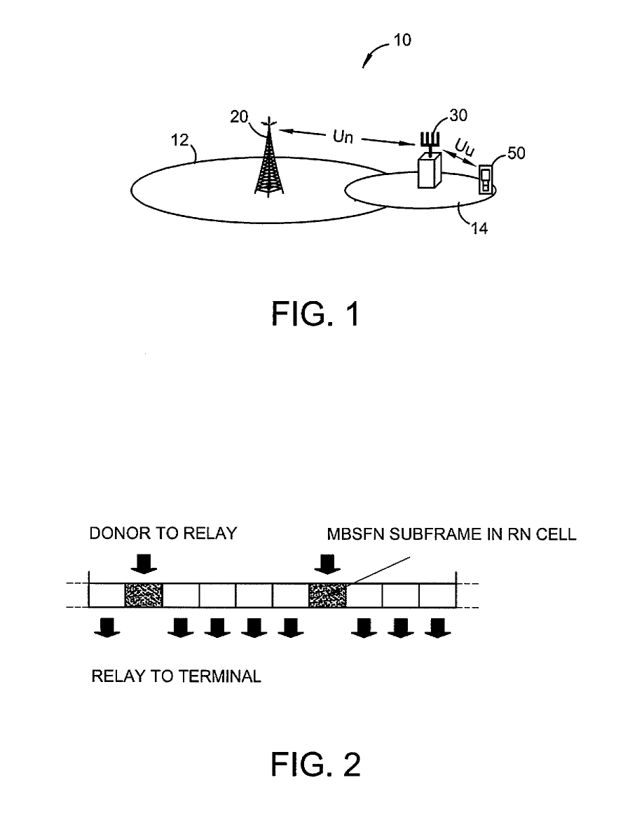

Turning now to the drawings, FIG. 1 illustrates an exemplary communication network 10 according to one exemplary embodiment of the present invention. The present invention is described in the context of a Long-Term Evolution (LIE) network, which is specified in Release 10 of the LTE standard. However, those skilled in the art will appreciate that the invention may be applied in networks using other communication standards.

The communication network 10 comprises a plurality of base stations 20 providing radio coverage in respective cells 12 of the communication network. Only one base station 20 is shown in FIG. 1. In the exemplary communication network 10, a relay node 30 relays signals between the base station 20 and one or more user terminals 50 in a relay cell 14. Relay node 30 is a type-1 relay as defined in Release 10 of the LTE standard.

For downlink communications, the relay node 30 receives signals from the base station 20 over the Un interface and transmits signals to the user terminals 50 over the Uu interface. For uplink communications, the relay node 30 receives signals from the user terminals 100 over the Uu interface and transmits signals to the base station over the Un interface. The Un interface is referred to herein as the backhaul link, and the Uu interface is referred to herein as the access link.

In one exemplary embodiment, the relay node 30 is an inband relay that transmits and receives on the same frequency. For good performance, the relay node 30 cannot transmit and receive at the same time on the same frequency due to self-interference. Therefore, for either uplink or downlink communications, certain subframes are designated for transmissions between the base station 20 and the relay node 30, and the remaining subframes are designated for transmissions between the relay node 30 and the user terminals 50.

For the downlink, certain subframes are designated for downlink transmissions from the base station 20 to the relay node 30 and the remaining subframes are designated for downlink transmissions from the relay node 30 to the user terminals 50. In one exemplary embodiment, the subframes designated for downlink transmissions from the base station 20 to the relay node 30 are configured as MBSFN subframes. During an MBSFN subframe, the user terminals in the relay cell do not expect to receive any reference signals or downlink data from the relay node 30 beyond what is transmitted in the first two OFDM symbols of the subframe. Instead, the relay node 30 listens to the downlink transmissions on the backhaul link.

Similarly, in the uplink, the relay node 30 cannot simultaneously listen to transmissions from the user terminals 50 on the access link and transmit to the serving base station 20 on the backhaul link. For uplink communications, interference can be avoided by not scheduling data transmissions from the user terminals 50 on subframes used to transmit data to the base station 20.

FIG. 2 illustrates an exemplary subframe allocation for downlink transmissions. A radio frame typically includes ten subframes, of which up to six subframes can be configured as MBSFN subframes. Subframes 0, 4, 5, and 9 cannot be configured for MBSFN. Thus, as many as six out of ten subframes in a radio frame can be used for downlink transmissions from the base station 20 to the relay node 30. The remaining subframes can be used for downlink transmissions from the relay node 30 to the user terminals 50. Thus, downlink transmissions from the base station 20 to the relay node 30 are time-multiplexed with the downlink transmissions from the relay node 30 to the user terminals 50.

A subframe allocation similar to FIG. 2 could also be made for uplink transmissions, however, it is not required that the same subframe allocations be used for uplink and downlink communications.

The optimal subframe allocation for a relay node 30 depends to some extent on the number of user terminals 50 served by the relay node and the interference experienced by the relay node 30. If the relay node 30 serves a large number of user terminals 50 so that the backhaul link is the bottleneck, it may be desirable to designate as many subframes as possible for downlink transmissions from the base station 20 to the relay node 30. On the other hand, when the access link is limiting, it may be beneficial to designate more subframes for transmissions from the relay node 30 to the user terminals 50. Other considerations in the subframe allocation include the quality of the backhaul link compared to the access link, and the ratio of the user terminals 50 served directly by the base station 20 to those served by relay nodes 30. Thus, the “best” allocation for the different relay nodes 30 may be different.

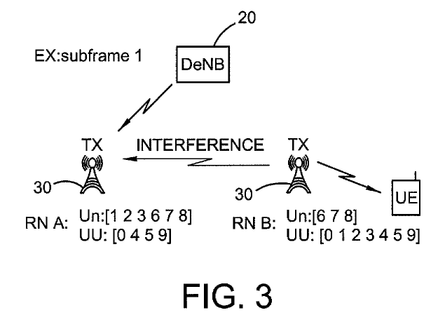

Configuring relay nodes with different subframe allocations may cause unwanted interference between the relay nodes. FIG. 3 illustrates the interference problem where neighboring relay nodes 30 use different subframe allocations. As used herein, the term “neighboring relay nodes” refers to relay nodes sufficiently close from a radio propagation perspective so that the transmissions from or to one relay node may interfere with transmission from or to another relay node. Neighboring relay nodes may be controlled by the same base station or by different base stations. In this example, relay node A uses subframes 1, 2, 3, 6, 7, and 8 to receive downlink transmissions from the base station 20, while relay node B uses subframes 6, 7, and 8. Thus, relay node B may transmit on subframes 1, 2, and 3 when relay node A is trying to receive data over the backhaul link. If the relay nodes 30 are not sufficiently separated from a radio propagation perspective, the interference from relay node B may become intolerable for relay node A, making it impossible for relay node A to receive transmissions from the base station 20 over the backhaul link. Thus, using different subframe allocations in different relay cells 14 makes deployment of relay nodes 30 more difficult, because greater care needs to be taken to make sure that the relay nodes 30 do not interfere with one another.

Generally, interference between relay nodes 30 using the same subframe allocation is not a problem. In this case, all relay nodes 30 will transmit signals to the user terminals 50 at the same time. The simultaneous transmission from multiple relay nodes 30 will create interference at the user terminals 50 receiving transmissions from either relay node 30, but that interference problem is the same as in any other re-use 1 system. Interference at the user terminal 50 can be handled by cell selection and hand-over. The problem arises when the relay nodes 30 have different subframe allocations because the transmissions from one relay node 30 may interfere with the reception of another relay node 30.

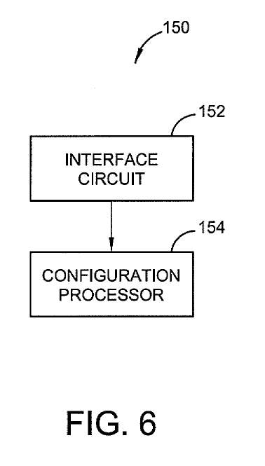

According to embodiments of the present invention, interference is avoided by coordinating the subframe allocation among different relay nodes 30. More particularly, a mechanism is provided to identify relay nodes 30 having the potential to create intolerable interference and a signaling scheme is provided to coordinate subframe allocations. In general, the procedure for determining the subframe allocation for a given relay node 30 involves two phases. In the first phase, the interference situation of the relay node 30 is evaluated to identify neighboring relay nodes with the potential to create intolerable interference. In the second phase, the interference information is evaluated to determine a subframe allocation that reduces the interference between neighboring relay nodes 30. The evaluation is typically performed by coordinating node 150 (FIG. 6) as hereinafter described.

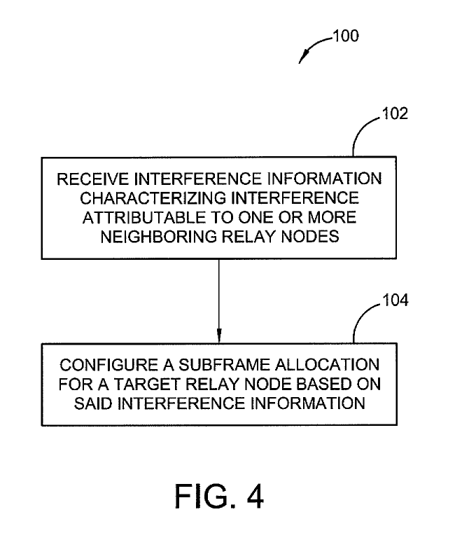

FIG. 4 illustrates an exemplary procedure 100 for determining the subframe allocation for a given relay node 30. The coordinating node 150 receives interference information characterizing the interference attributable to one or more relay nodes 30 (block 102). After receiving the interference information, the coordinating node 150 configures a subframe allocation for a target relay node based on the received interference information (block 104). The coordinating node 150 may be a centralized node in the communication network 10 responsible for subframe allocation for relay cells 14 in a radio access network. For example, an Operations and Maintenance server (OAM) in the core network may serve as a coordinating node 150. Alternatively, the responsibility for subframe allocation in a radio access network may be distributed among two or more coordinating nodes 150. In this case, the base station 20 may serve as coordinating nodes 150.

The interference information may, for example, comprise a list of interfering relay cells 14 with some indication of the interference level. For example, the received signal strength (RSRP) from the interfering cells may serve as one measure of the interference levels. In other embodiments, the interference information may comprise a list of interfering relay cells 14 on a per subframe basis, with or without an indication of the interference level. The interference information may be manually collected by a service technician using the relay node 30 or other equipment to perform measurements. The interference information can then be input to the coordinating node via a conventional user interface. For example, the service technician could input the interference information into an OAM functioning as a coordinating node 150. Alternatively, measurements may be performed by the relay node 30 or other equipment connected to the relay node 30. The measurements can be processed to generate interference information, which is then reported to the coordinating node 150 over a communications link. The manual approach is simpler to implement because it does not require any new signaling. However, the interference environment may change as new buildings are constructed or new relay cells are added to the network. The time and labor involved make the manual approach costly to implement on a frequent basis. Further, the manual approach is subject to human error. The automatic approach enables more frequent update of the subframe allocations as the interference environment changes. However, new signaling may be required to implement the automatic approach.

There are several alternatives for signaling interference information between a node where the measurements are made and a coordinating node 150 where the decision on subframe allocation is made. In one exemplary embodiment, the relay nodes 30 may use a signaling to report interference information to an OAM functioning as the coordinating node 150 for all relay cells 14 in a radio access network. In another exemplary embodiment, the base station 20 may function as coordinating nodes 30 to determine the subframe allocations for the relay nodes 30 served by the base station 20. In this case, the relay nodes 30 may signal interference information to the base station 20 using radio resource control (RRC) signaling, X2, or other signaling. The base stations 20 may use the X2 signaling interface to share interference information reported by the relay nodes 30. In either case, once the interference information is available to the coordinating node 150, the coordinating node 150 may use the interference information to determine the subframe allocations.

In one exemplary embodiment, the relay nodes 30 provide the coordinating node with a list of neighboring relay nodes 30 and the corresponding signal strength measurements (RSRPs) to provide an indication of the interference level. Subframe allocations may be based, at least in part, on comparison of the signal strength measurements to a threshold. The threshold can be a fixed value, or may vary dynamically, depending on operating conditions. For example, the threshold may depend on the backhaul link quality for the relay node 30 because it is the backhaul link that suffers interference from a neighboring relay node 30 with a different subframe configuration. The relay nodes 30 may report the received signal strength from the serving base station 20 in addition to the interference information. The threshold may be set at a point that is safely below the received signal strength from the serving base station 20 so that different subframe configurations may be allowed when the interference level is below the threshold.

In one exemplary embodiment, one or more relay node pools may be defined where the relay nodes in the same relay node pool use the same subframe allocation pattern. In this case, determining the subframe allocation pattern reduces to determining the relay node pool for the relay node 30. In general, the interference between relay nodes 30 in the same pool will be high, whereas the interference between relay nodes 30 in different pools will be low.

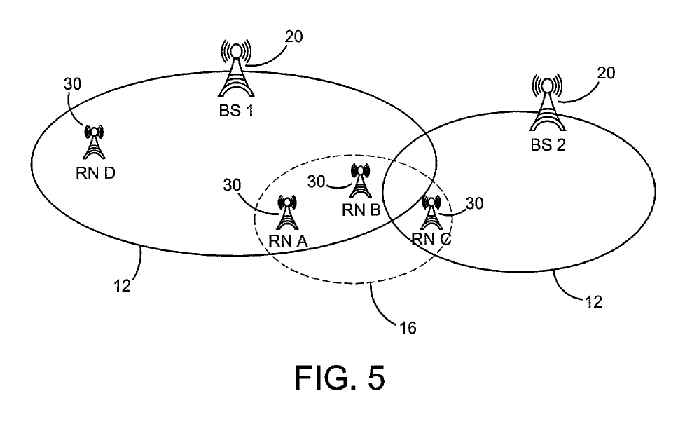

FIG. 5 illustrates the concept of relay node pools. FIG. 5 shows a relay node pool 16 comprise three relay nodes 30 designated as relay nodes A, B, and C. The relay nodes 30 in a relay node pool 16 may all be served by the same base station 20 or, as shown in FIG. 5, may be served by different base stations 20.

In systems where the subframe allocations are determined by a centralized coordinating node (e.g., OAM) 150, the coordinating node 150 needs to signal the subframe allocation to each base station 20 and relay node 30. In systems where the base stations 20 serve as coordinating nodes, the base stations 20 need to signal the subframe allocations to the relay nodes 30 under the control of the base station 20.

The base station 20 and relay nodes 30 may store a table of subframe allocation patterns in memory. In this case, the subframe allocation can be signaled by sending an index indicating which of the subframe allocations stored in memory has been selected. Coordinating node 150 may send an index to indicate a particular subframe allocation pattern. In some embodiments, the relay node 30 may be part of a relay node pool. In this case, the index may indicate the pool to which the relay node is assigned, which is an implicit indication of the subframe allocation pattern. In some embodiments, the relay node pool may be assigned multiple subframe allocations patterns. In this case, the index needs to indicate the pool and subframe allocation pattern (e.g., pool 1, pattern 3).

In embodiments where the decision making concerning subframe allocation patterns is centralized, coordination of the subframe allocation patterns for relay nodes served by different base stations is simplified. Referring to FIG. 5, relay nodes A and B are served by base station 1, while relay node C is served by base station 2. It is assumed in this example that relay nodes A, B, and C are creating interference with one another and should be placed in the same relay node pool 16. If the subframe allocation is made by a centralized node, e.g., OAM, the coordinating node 150 may indicate to the serving base station 1 that relay nodes A and B should be assigned to the same relay node pool 16. The OAM can also indicate to serving base station 2 that relay node C should be assigned to the same pool 16.

Where the decision making for subframe allocation is distributed between the serving base stations 20, the serving base stations 20 will need to exchange interference information and negotiate the subframe allocation patterns. In this example, relay nodes A and B will report interference from relay node C to serving base station 1. Similarly, relay node C will repot interference from relay nodes A and B to serving base station 2. The interference information may be shared between the base stations 20. The base stations 20 can then negotiate the subframe allocation for relays A, B, and C. For example, serving base station 1 may indicate a desired subframe allocation pattern for relays A, B, and C to base station 2. Base station 2 can either accept the proposed subframe allocation, or reject the allocation and propose a different subframe allocation pattern. This process can be repeated until the base stations 20 have agreed upon the subframe allocation pattern.

FIG. 6 illustrates the main functional components of a coordinating node 150 for coordinating the subframe allocation patterns. The coordination node 150 comprises an interface circuit 152 and a configuration processor 154. The interface circuit 152 may comprise a user input interface to receive interference information from a system user. Alternatively, or in addition, the interface circuit 152 may comprise a network interface over which the interference information is received. The configuration processor 154 may comprise one or more microprocessors, hardware, firmware, or a combination thereof, for processing the interference information and making decisions on subframe allocation patterns. As previously noted, the interface circuit 152 and configuration processor 154 may be embodied in a centralized node such as an OAM. Alternatively, the interface circuit 152 and configuration processor 154 may be embodied in a base station 20

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method of configuring a target relay node comprising;
receiving interference information characterizing the interference attributable to one or more other relay nodes; and
configuring a subframe allocation for the target relay node based on the interference attributable to said other relay nodes.

2. The method of claim 1 wherein receiving interference information comprises, receiving said interference information via a user input interface.

3. The method of claim 1 wherein receiving interference information comprises receiving said interference information over a communication link from one or more relay nodes.

4. The method of claim 1 wherein configuring a subframe allocation for the target relay node based on the interference attributable to one or more other relay nodes comprises selecting a subframe allocation to mitigate interference during subframes when the target relay node is receiving transmissions.

5. The method of claim 4 wherein configuring a subframe allocation for the target relay node comprises:
determining whether the interference attributable to one of said other relay nodes exceeds a threshold; and
if the interference exceeds a threshold, configuring a subframe allocation for the target relay node so that the other relay node is not transmitting when the target relay node is receiving a transmission.

6. The method of claim 5 wherein configuring a subframe allocation comprises configuring a subframe allocation for the target relay node so that the other relay node is not transmitting on an access link when the target relay node is receiving a transmission on a backhaul link from a serving base station.

7. The method of claim 5 wherein configuring a subframe allocation comprises configuring a subframe allocation for the target relay node so that the other relay node is not transmitting to serving base station on an backhaul link when the target relay node is receiving a transmission from a user terminal on a access link.

8. The method of claim 5 further comprising adjusting the threshold in dependence on the quality of the backhaul link between the target relay node and the serving base station.

9. The method of claim 4 wherein configuring a subframe allocation for the target relay node comprises assigning the target relay node to a relay node pool including the other relay node, wherein all the relays in the relay node pool use a common subframe allocation.

10. The method of claim 9 wherein the relay nodes in the relay node pool are served by two or more base stations.

11. A coordinating node in a communication network for configuring a relay node, said management node comprising:
an interface to receive interference information regarding one or more neighbor relay nodes; and
a processor adapted to configure a subframe allocation for said relay node based on the interference from said other relay nodes.

12. The coordinating node of claim 11 wherein the interface comprises a user input interface.

13. The coordinating node of claim 11 wherein the interface comprises a signaling interface for receiving said interference information over a communication link from one or more relay nodes.

14. The coordinating node of claim 11 wherein the processor is adapted to configure a subframe allocation for the target relay node to mitigate interference during subframes when the target relay node is receiving transmissions.

15. The coordinating node of claim 11 wherein the processor is adapted to configure a subframe allocation for the target relay node by:
determining whether the interference attributable to one of said other relay nodes exceeds a threshold; and
if the interference exceeds a threshold, configuring a subframe allocation for the target relay node so that the other relay node is not transmitting when the target relay node is receiving a transmission.

16. The coordinating node of claim 15 wherein the processor is adapted to configure a subframe allocation for the target relay node such that the other relay node is not transmitting on an access link when the target relay node is receiving a transmission on a backhaul link from a serving base station.

17. The coordinating node of claim 15 wherein the processor is adapted to configure a subframe allocation for the target relay node such that the other relay node is not transmitting to serving base station on an backhaul link when the target relay node is receiving a transmission from a user terminal on a access link.

18. The coordinating node of claim 15 wherein the processor is further adapted to adjust the threshold in dependence on the quality of the backhaul link between the target relay node and the serving base station.

19. The coordinating node of claim 14 wherein the processor is further adapted to configure a subframe allocation for the target relay node by assigning the target relay node to a relay node pool including the other relay node, wherein all the relays in the relay node pool use a common subframe allocation.

20. The coordinating node of claim 19 wherein the relay nodes in the relay node pool are served by two or more base stations.
